(19) United States
(12) Patent Application Publication
(10) Pub. No.: US 2026/0268441 A1
(43) Pub. Date: Sep. 10, 2026

(54) ON-DEVICE IMAGE GENERATION WITH GENERATIVE ADVERSARIAL NETWORKS

(71) Applicant: Google LLC, Mountain View, CA (US)

(72) Inventors: Haolin Jia, Jersey City, NJ (US); Qifei Wang, Sunnyvale, CA (US); Omer Tov, Kadima-Zoran (IL); Yang Zhao, Bellevue, WA (US); Fei Deng, Piscataway, NJ (US); Lu Wang, Redwood City, CA (US); Chuo-Ling Chang, Mountain View, CA (US); Tingbo Hou, Santa Clara, CA (US); Matthias Grundmann, San Jose, CA (US)

(21) Appl. No.: 19/491,309

(22) PCT Filed: Jun. 6, 2024
(86) PCT No.: PCT/US2024/032869

§ 371 Date: Dec. 8, 2025

Related U.S. Application Data
(60) Provisional application No. 63/506,570, filed on Jun. 6, 2023.

(51) Int. Cl. G06T 3/4046; G06N 3/045; G06N 3/08; G06T 3/4053

(52) U.S. Cl. CPC G06T 3/4046; G06N 3/045; G06N 3/08; G06T 3/4053

(57) ABSTRACT

Methods, systems, and apparatus, including computer programs encoded on computer storage media, for generating images. For example, the system can perform low-latency on-device image generation using a generator neural network.

### CROSS-REFERENCE TO RELATED APPLICATION

This application claims the benefit of U.S. Provisional Application Ser. No. 63/506,570, filed Jun. 6, 2023, which is incorporated by reference herein.

### BACKGROUND

This specification relates to generating images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that generates images using a generator neural network.

Particular embodiments of the subject matter described in this specification can be implemented so as to realize one or more of the following advantages.

This specification generally describes techniques for generating images using a generator neural network. In particular, the architecture of the generator neural network is designed to be computationally efficient to allow the generator neural network to, when deployed on an edge device, generate images with minimal latency while still generating high-fidelity images, e.g., for unconditional or conditional face image generation. For example, the generator neural network can be used to generate images in real-time in response to user requests when deployed on an edge device. Furthermore, computational and communication network resource consumption can be reduced by deploying the generator neural network locally on an edge device (e.g., relative to when the generator neural network is deployed on a remote computing device).

As a particular example, relative to a more computationally expensive teacher neural network, the convolutional blocks within the generator neural network can operate on latent representations that have significantly reduced resolutions relative to their counterparts in the teacher neural network, e.g., that operate on latent representations that are ¼ of the resolution of the resolutions in the teacher neural network. This greatly reduces the complexity of the convolutional blocks, resulting in a significantly more computationally efficient neural network. This reduction in complexity can be achieved while still maintaining high generation quality by the inclusion of an upsampling operation in the output head of the neural network. That is, because the output head of the neural network includes an upsampling operation block, the convolutional blocks do not need to upsample the latent representation to the final, target resolution of the output image.

Additionally, this specification describes techniques for training the generator neural network to effectively generate images, i.e., with a quality that matches or exceeds that of more computationally expensive architectures. For example, during training, the generator neural network can be augmented with auxiliary output heads that generate lower-resolution images and that can be used to improve the effectiveness of the training. Like the output head described above, each of these auxiliary output heads can also include an upsampling block, allowing for the parameter efficient architecture described above to still receive a rich training signal.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for generating an output image.

FIG. 3 shows an example of the architecture of a convolutional block.

FIG. 4 shows an example of the architecture of the output head.

FIG. 5 is a flow diagram of an example process for training the generator neural network.

FIG. 6 shows an example of training the generator neural network.

FIG. 7 shows an example of the computational efficiency of the described techniques.

FIG. 8 shows an example of the inference times of the described techniques when deployed on common mobile devices.

Like reference numbers and designations in the various drawings indicate like elements.

### DETAILED DESCRIPTION

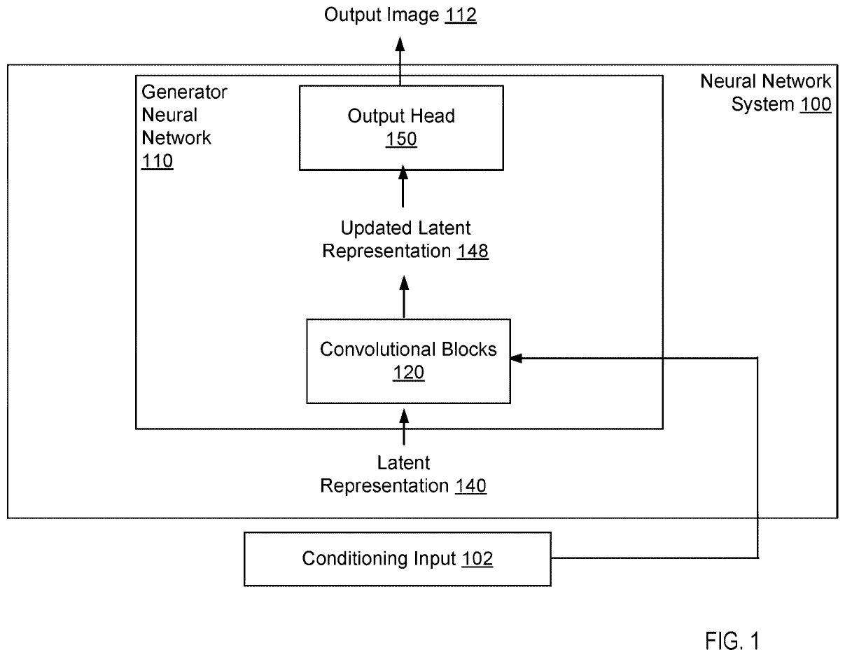

FIG. 1 shows an example neural network system 100. The neural network system 100 is an example of a system implemented as computer programs on one or more computers in one or more locations, in which the systems, components, and techniques described below can be implemented.

The system 100 generates images 112 using a generator neural network 110 conditioned on a conditioning input 102.

For example, the images 112 can be images of faces, i.e., of faces of humans or other animals.

The generator neural network 110 includes a sequence of convolutional layer blocks 120 and an output head 130.

To generate an image 112, the system 100 initializes a latent representation 140 of the output image 112. The latent representation 140 is a spatial feature map that has an initial resolution and includes a respective feature vector at each of multiple spatial locations.

The generator neural network 110 then processes the latent representation 140 of the output image 112 through the sequence of convolutional layer blocks 120 to update the latent representation 140, i.e., to generate an updated latent representation 148.

Each convolutional network block 120 is a collection of one or more neural network layers that includes one or more convolutional neural network layers. As will be described in more detail below, each of the blocks 120 is configured to upsample the latent representation 140, i.e., so that the input to each of the blocks 120 is a latent representation having a respective input resolution and the output of the block 120 is a latent representation having an output resolution that is higher than the input resolution.

The generator neural network 110 then processes the updated latent representation 148 using the output head 150 to generate the output image 112 from the updated latent representation 148.

The output head 150 is configured to map the updated latent representation 148 to an output image.

In particular, the architecture of the generator neural network 110 is designed to be computationally efficient to allow the generator neural network 110 to, when deployed on an edge device, generate images with minimal latency while still generating high-fidelity images, e.g., for unconditional or conditional face image generation. For example, the generator neural network 110 can be used to generate images in real-time in response to user requests when deployed on an edge device.

That is, in some implementations, the system 100 is deployed on an edge device, e.g., a mobile device, e.g., a smartphone or a tablet, a smart speaker or another embedded computing device, and so on. In other words, the system 100 is implemented as one or more computer programs running on the edge device. In these implementations, once generated, the system 100 can display the generated image in a user interface of the edge device.

Generally, the generation of the output image 112 is conditioned on a conditioning input 102. The conditioning input 102 characterizes properties of the output image 112. For example, the conditioning input 102 can characterize a style of the output image 112.

As another example, the conditioning input 102 can represent an input image, i.e., so that the output image 112 is an adapted version of the input image, e.g., an edited version of the input image or a version of the input image after a style transfer task has been performed on the input image.

More specifically, each of the convolutional blocks 120 can update the latent representation 140 conditioned on the conditioning input 102.

Generating the conditioning input 102 and conditioning the convolutional blocks 120 on the conditioning input 102 are described in more detail below.

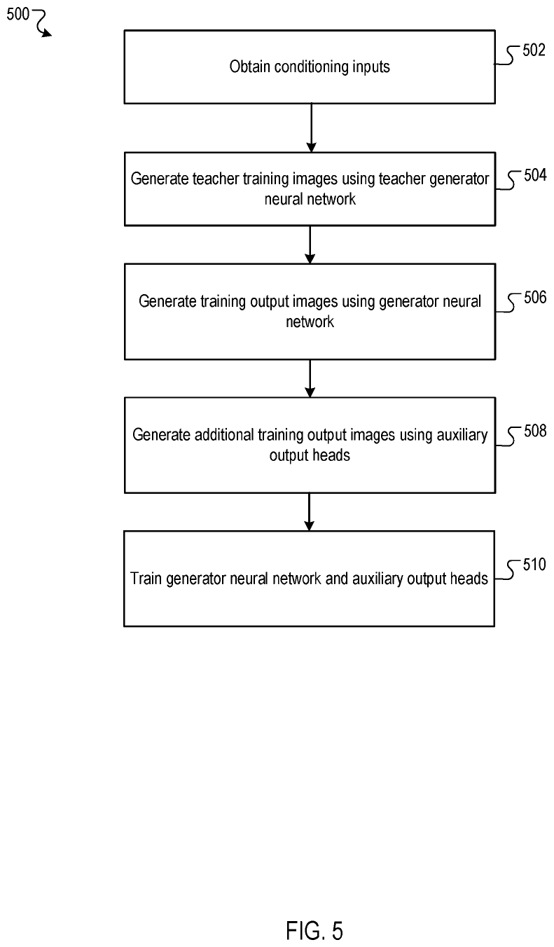

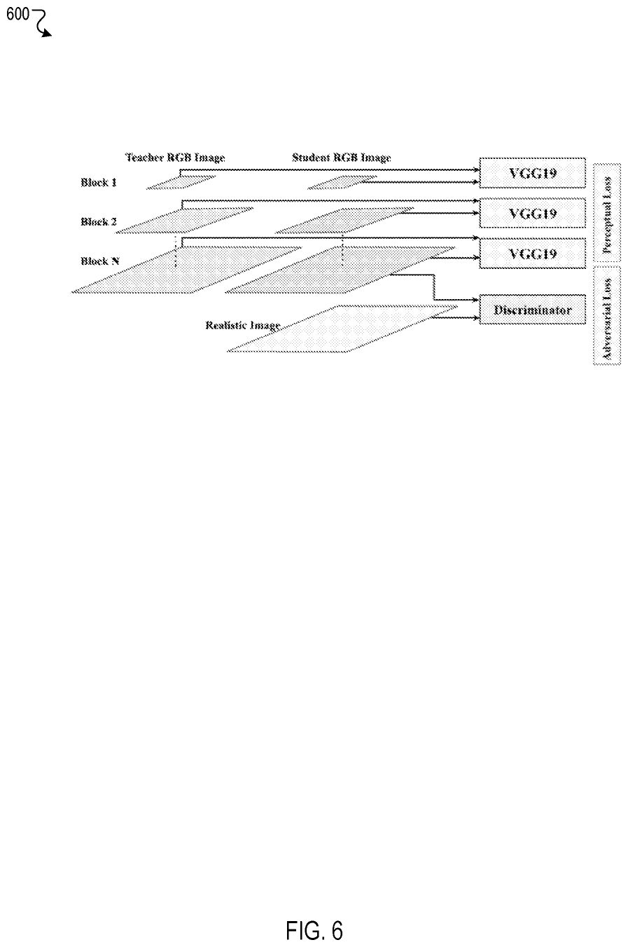

Prior to using the neural network 110 to generate images, the system 100 or another system trains the neural network 110. One example of this training is described below with reference to FIGS. 5 and 6.

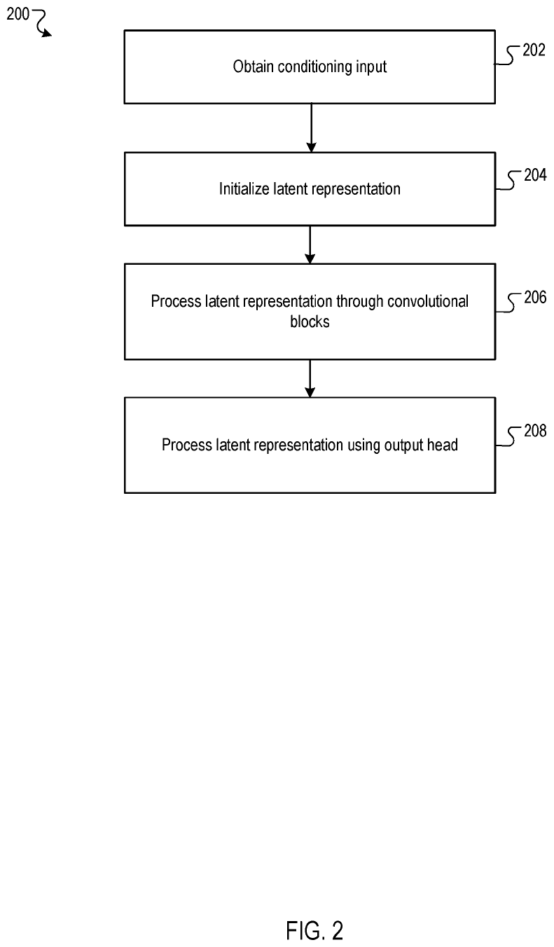

FIG. 2 is a flow diagram of an example process 200 for generating an output image. For convenience, the process 200 will be described as being performed by a system of one or more computers located in one or more locations. For example, a neural network system, e.g., the neural network system 100 of FIG. 1, appropriately programmed, can perform the process 200.

The system obtains a conditioning input (step 202).

For example, the system can obtain an input latent representation (also referred to as a “latent code”) and then process the input latent representation using a mapping neural network to generate the conditioning input. In other words, the conditioning input can represent an input latent representation which has been mapped to an intermediate latent space. The input latent representation is an ordered collection of numerical values, e.g., a vector or a matrix. Generally, each input latent representation is selected from a space of possible latent representations, e.g., the space of vectors or matrices having a specified dimensionality.

The mapping neural network can generally have any appropriate architecture. As one example, the mapping neural network can be a multi-layer perceptron (MLP). Generally, the mapping neural network is trained jointly with the generator neural network, e.g., using the training technique described below with reference to FIGS. 5 and 6.

In some of these cases, the input latent representation is sampled from a distribution, i.e., a distribution over a space of input latent representations, either by the system or by a user of the system.

In some others of these cases, the input latent representation is provided by a user. For example, a user can submit an input specifying a vector or matrix from the space that will be used as the input latent representation.

In yet other of these cases, the system receives an input characterizing properties of the target image and processes the input characterizing the properties of the target image to generate the input latent representation.

As a particular example, the system can receive an input image and perform an image inversion technique to map the input image to an input latent representation in the space of input latent representations. This effectively conditions the generator neural network on the input image, i.e., so that the output image that will be generated will be an adapted version of the input image.

For example, to support image-to-image stylization, the system can use an encoder neural network to map input images to the latent space of the generator. For example, the encoder neural network can be, e.g., a convolutional neural network, e.g., that has the architecture of a MobileNet V2 backbone or other convolutional architecture.

This encoder neural network can be trained in any appropriate way on a set of target images, e.g., natural face images when the generator generates images of faces. As one example, the loss can be a combination of image perceptual quality loss, which measures the content difference, style similarity and embedding distance, as well as an L1 loss or other loss between the input images and reconstructed images.

As another particular example, the system can receive a text input or a structured input specifying properties of the output image and then map the input to an input latent representation, e.g., using a learned mapping that has been learned after the generator neural network has been trained.

As one example, the generator neural network can have been trained to generate images that depict objects of a particular type, e.g., faces of people, or images of a particular style, e.g., realistic, cartoon, impressionist, and so on, or both, i.e., trained to generate images of a particular type with a particular style. In this example, the input latent representation can define the specific content of the generated image, i.e., the properties of the object of the particular type that will be depicted in the image. Thus, the output image generated by the generator neural network will include the specific content defined by the initial latent representation and, in some cases, will be in the particular style that the generator neural network has been trained to generate.

The system then generates, from the conditioning input, i.e., conditioned on the conditioning input, an output image having a target resolution.

To generate the output image, the system initializes a latent representation of the output image to have an initial resolution (step 204). The initial resolution is generally lower than the target resolution of the output image.

For example, the latent representation can be a fixed latent representation that is the same for all output images generated by the system. As a particular example of this, the fixed latent representation can have been learned during the training of the generator neural network.

As another example, to initialize the latent representation, the system can apply a transformation to the conditioning input to generate the latent representation that has the initial resolution.

The system processes the latent representation through a sequence of convolutional layer blocks (step 206).

Each convolutional layer block is configured to upsample the latent representation by processing the latent representation through an upsampling layer block to generate an upsampled latent representation.

As a result of the upsampling, the upsampled latent representation has a corresponding resolution that is higher than the resolution of the latent representation received as input by the convolutional layer block.

Thus, as a result of the upsampling, for each convolutional block after the first convolutional layer block in the sequence, the corresponding resolution for the convolutional layer block is higher than the corresponding resolution for the preceding convolutional layer block in the sequence. For the first convolutional layer block in the sequence, the corresponding resolution for the convolutional layer block is higher than the initial resolution at which the latent representation is initialized.

Generally, the corresponding resolution for the last convolutional layer block in the sequence is lower than the target resolution. That is, although each convolutional layer block upsamples the latent representation to increase the resolution of the latent representation, the resolution of the latent representation after being updated by the last convolutional layer block is still lower than the target resolution of the output image.

The convolutional layer block then updates the latent representation by processing the upsampled latent representation through one or more styled convolutional layer blocks that are each conditioned on the conditioning input.

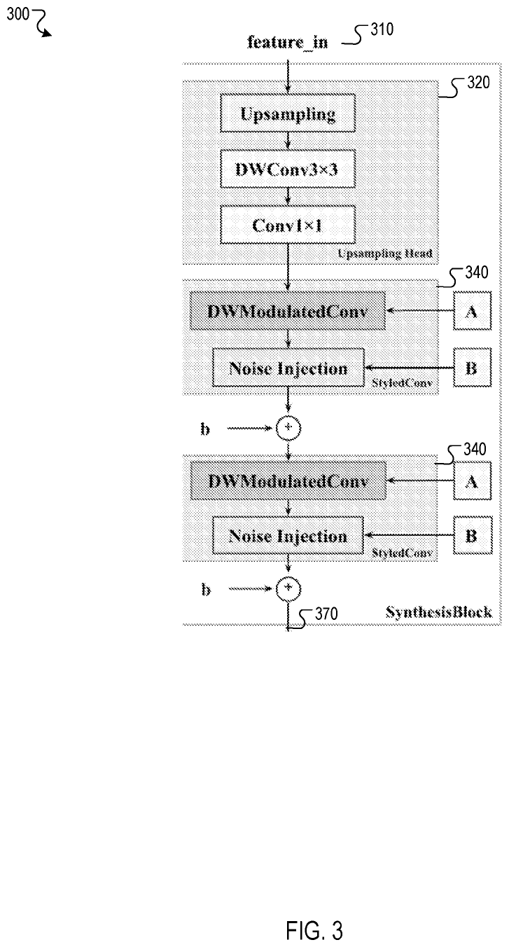

The operations performed by a convolutional block will be described in more detail below with reference to FIG. 3.

The system then processes the latent representation after being updated by the last convolutional layer block in the sequence using an output head (step 208).

The output head is configured to generate, from the latent representation, a final upsampled latent representation having the target resolution by processing the latent representation through an upsampling layer block.

The output head can then apply a depthwise separable modulated convolution conditioned on the conditioning input to the final upsampled latent representation to generate an initial output image having the target resolution.

In some implementations, the initial output image is the (final) output image that is generated by the system. In some other implementations, the output block adds a learned bias to the initial output image to generate the (final) output image having the target resolution.

By including the upsampling block within the output head, the system allows the convolutional blocks (which include the majority of the parameters of the generator neural network) to operate on lower resolution latent representations than their counterparts in other generator neural networks. As a result, while other generator neural networks are not able to generate images real-time when deployed on an edge device, the described generator neural network is computationally efficient enough to generate images on-device with minimal latency.

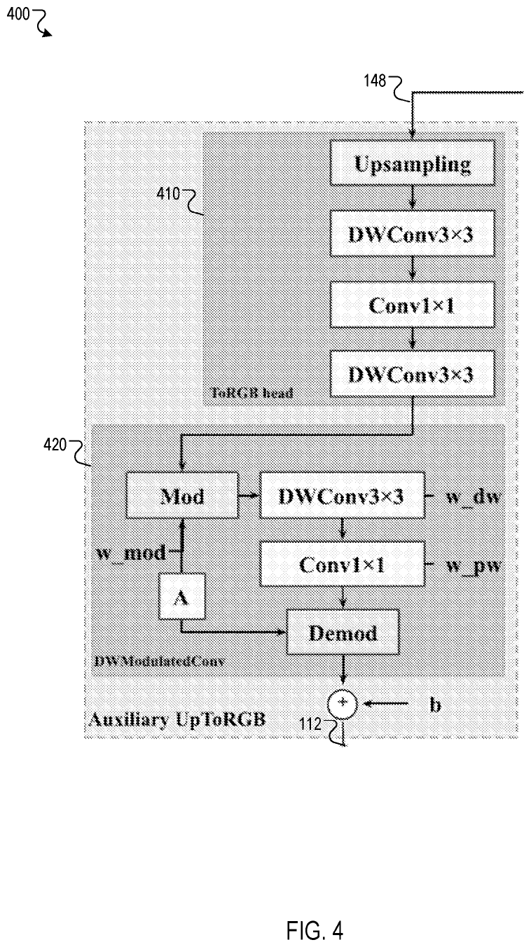

The operations performed by the output head will be described in more detail below with reference to FIG. 4.

FIG. 3 shows an example 300 of the architecture of a convolutional block 120.

As shown in the example 300, the convolutional block 120 receives a latent representation 310 and processes the latent representation 310 to update the latent representation, i.e., to generate an updated latent representation 370. As described above, the updated latent representation 307 has a higher resolution than the latent representation 310.

In the example 300, the convolutional block 120 includes an upsampling layer block 320 that processes the latent representation 310 to generate, from the latent representation 310, an upsampled latent representation having a corresponding resolution for the convolutional layer block 120.

For example, the upsampling layer block 320 can apply an upsampling operation to the latent representation to generate an initial upsampled latent representation having the corresponding resolution for the convolutional layer block. The upsampling operation can be any appropriate upsampling operation that increases the resolution of the input to the operation to a predetermined higher resolution.

In the example 300, the upsampling layer block 320 then processes the initial upsampled latent representation through a depthwise separable convolution block to generate the upsampled latent representation. The depthwise separable convolution block includes a depthwise convolution (DWconv3x3) followed by a pointwise convolution (Conv1x1). Making use of a depthwise separable convolution in this manner is generally more computationally efficient than a standard convolution.

The convolutional block 120 also includes one or more styled convolutional layer blocks 340 and updates the latent representation by processing the upsampled latent representation through the one or more styled convolutional blocks 340.

In the example of FIG. 3 the block 120 includes two styled convolutional layer blocks 340.

Each of the blocks 340 is conditioned on the conditioning input. In particular, each block 340 receives an input (“A”) that is based on, e.g., derived from, the conditioning input. For example, the input A for a given block 340 can be generated by applying a learned affine transformation to the conditioning input. As another example, the input A for a given block 340 can be generated by applying a learned affine transformation to a corresponding portion of the conditioning input. As a particular example of this, the conditioning input can include a “shared” conditioning input that is common to all blocks 340 and a respective “delta” for each block 120 or each block 340. In this example, the corresponding portion for a given block 340 can be a combination, e.g., a sum or a difference, of the shared conditioning input and the respective delta corresponding to the block 340.

The learned affine transformations can generally be different for different blocks 120 within the network 110 and, in some cases, for different styled convolutional layer blocks 340 within the same block 120.

Each styled convolutional layer block 340 is configured to update the upsampled latent representation by processing the upsampled latent representation through a depthwise separable modulated convolution layer (DWModulatedConv) using the input A. A DWModulatedConv layer is described in more detail below with reference to FIG. 4.

Each styled convolutional block 340 is also configured to add noise B to the updated upsampled latent representation, i.e., by performing noise injection.

For example, each block 340 can sample a noisy latent representation, i.e., by sampling each value in the noisy latent representation from a specified distribution, e.g., a Gaussian distribution or other appropriate distribution, and then add the noisy latent representation to the updated upsampled latent representation.

As another example, each block 340 can maintain a learned weight vector that includes a respective weight for each channel of the updated upsampled latent representation. The block 340 can then sample a single-channel noisy latent representation and generate the noisy latent representation by, for each channel, multiplying the weight for the channel with the single-channel noisy latent representation. The block 340 can then add the noisy latent representation to the updated upsampled latent representation.

Optionally, after each block 340, the block 120 can add a learned bias (“b”) to the output of the block 340.

FIG. 4 shows an example 400 of the architecture of the output layer block 150.

As described above, the output head 150 is configured to generate, from the latent representation 148, a final upsampled latent representation having the target resolution by processing the latent representation through an upsampling layer block 410.

For example, the upsampling layer block 410 can apply an upsampling operation to the latent representation to generate an initial upsampled latent representation having the target resolution. The upsampling operation can be any appropriate upsampling operation that increases the resolution of the input to the operation to a predetermined higher resolution, i.e., the target resolution.

In the example 300, the upsampling layer block 410 then processes the initial upsampled latent representation through a depthwise separable convolution block followed by a depthwise convolution (DWconv3x3). The depthwise separable convolution block includes a depthwise convolution (DWconv3x3) followed by a pointwise convolution (Conv1x1).

The output head 150 can then apply a depthwise separable modulated convolution layer 420 conditioned on the conditioning input, e.g., that receives the input A, to the final upsampled latent representation to generate an initial output image having the target resolution.

Generally, the depthwise separable modulated convolution layer 420 transforms the latent representation to RGB via a single frequency domain transformation.

Generally, a depthwise separable modulated convolution layer receives an input x (e.g., a latent representation) and applies a modulation to the input x using the input A to generate a modulated input x′. For example, the head can have generated the input A by applying an affine transformation with weights w_mod to the conditioning input or a portion of the conditioning input as described above. The modulation can be applied as, e.g., a convolution between A and x. The layer then applies a depthwise separable convolution to the modulated input x′ (a depthwise convolution (DWconv3x3) with weights w_dw followed by a pointwise convolution (Conv1x1) with weights w_pw) to the modulated input x′ to generate a modulated output x′″. The layer then applies demodulation to the modulated output x′″ to generate the output of the layer x_out. In some cases, the demodulation can be trainable demodulation that determines the kernel to be applied to the modulated output x′″ using a set of learned parameters.

Moreover, in some cases, after training, the demodulation can be merged into the weights of the pointwise convolution to improve efficiency by decreasing the computational complexity of the network at inference time.

Depthwise separable modulated convolution layers are described in more detail in Sergei Belousov. MobileStyleGAN: A lightweight convolutional neural network for high-fidelity image synthesis. arXiv preprint arXiv: 2104.04767, 2021, the entire contents of which are hereby incorporated herein in their entirety.

In some implementations, the initial output image is the (final) output image 112 that is generated by the system. In some other implementations, the output block adds a learned bias to the initial output image to generate the (final) output image 112 having the target resolution.

Prior to using the generator neural network 110 to generate new images, e.g., prior to deploying the generator neural network 110 on an edge device, a training system trains the generator neural network 110 on a set of training data.

In some cases, the training system trains the generator neural network 110 using a teacher generator neural network.

The teacher generator neural network is a neural network that has already been trained to generate images. For example, the teacher generator neural network can be a neural network that can generate high-quality images but that is too computationally expensive for use in generating images on-device with low latency, e.g., because the teacher generator neural network is too large to fit on the edge device or because the teacher generator neural network generates images with an excessive latency when deployed on the edge device.

One example of such training is shown below in FIG. 5.

FIG. 5 is a flow diagram of an example process 500 for training a generator neural network. For convenience, the process 500 will be described as being performed by a system of one or more computers located in one or more locations. For example, a neural network system, e.g., the neural network system 100 of FIG. 1 or a training system, appropriately programmed, can perform the process 500.

The system obtains a batch of training conditioning inputs (step 502). For example, the system can obtain each conditioning input by randomly sampling an input latent representation from the space of input latent representations and then processing the sampled latent representation using the mapping neural network.

The system processes each training conditioning input through the teacher generator neural network to generate, for each training conditioning input, a plurality of training teacher images (step 504). Each training teacher image has a respective teacher target resolution and one of the teacher target resolutions is the target resolution. For example, one of the training teacher images can have the target resolution and the remainder of the training teacher images can have a respective teacher target resolution that is lower than the target resolution.

In some implementations, the system can generate these images by using the teacher neural network to generate a single training teacher image having the target resolution and then resizing the single training teacher image to have each of the other teacher target resolutions.

In other implementations, the teacher neural network can include a respective output head corresponding to each of the teacher target resolutions and that generates output images having the corresponding teacher target resolution.

The system processes each training conditioning input through the generator neural network to generate, for each training conditioning input, (i) a training output image having the target resolution and (ii) a respective latent representation having the resolution corresponding to each of the convolutional layer blocks (step 506). For example, the system can generate (i) and (ii) as described above with reference to FIGS. 2 and 3.

For each training conditioning input and for each convolutional layer block, the system processes the respective latent representation having the resolution corresponding to the convolutional layer block using a corresponding auxiliary output head to generate as output a training output image having a corresponding one of the teacher target resolutions (step 508).

That is, during training, the generator neural network includes a corresponding auxiliary output head for each convolutional block that maps the respective latent representation having the resolution corresponding to the convolutional layer block to a training output image having a corresponding one of the teacher target resolutions. For example, the auxiliary output heads can have the same architecture as the output head 150. In other words, the auxiliary output heads can each also include an upsampling block, meaning that, although the latent representation as updated by a given convolutional block is used to generate an image having a corresponding teacher resolution, the resolution of the latent representation can be lower than the corresponding teacher resolution, maintaining the computational efficiency of the generator neural network.

Thus, during training, given a conditioning input, the generator neural network can generate a respective output image having each of the teacher target resolutions (rather than just one output image having the target resolution).

The system trains the generator neural network and the auxiliary output heads on an objective that measures, for each training conditioning input and for each teacher target resolution, a difference between the training teacher image having the teacher target resolution and the training output image having the teacher target resolution (step 510). For example, the objective can measure a sum, a weighted sum, or an average of the differences for each of the teacher target resolutions.

The system can generally use any appropriate measure of the difference between two images as the difference in the objective. As one example, the difference can be a perceptual loss between the training teacher image having the teacher target resolution and the training output image having the teacher target resolution.

After training, the system can discard the auxiliary output heads and leave only the output head 150 as part of the generator neural network.

In some implementations, the system also incorporates a discriminator neural network into the training of the generator neural network. The discriminator neural network is a neural network that processes a given image to generate as output a discriminator score that predicts whether the given image is generated by the generator neural network.

In these implementations, for each training conditioning input, the system processes the training output image having the target resolution using the discriminator neural network to generate as output a discriminator score that predicts whether the training output image is generated by the generator neural network.

The system then includes, as part of the objective, a term that is based on the discriminator scores for the training conditioning inputs, i.e., that penalizes the generator neural network for generating output images that are accurately classified by the discriminator neural network as having been generated by the generator neural network. For example, for a given training score, the term can be the negative of a non-saturating function applied to the discriminator score.

At some or all of the training iterations, the system can also train the discriminator neural network to accurately distinguish between training output images generated by the generator neural network and real images obtained from an existing data set of images. The system can generally use any appropriate adversarial discriminator loss as the loss for training the discriminator neural network. For example, the discriminator loss can be the sum of (i) the negative of the output of the non-saturating function applied to a discriminator score for a real image and (ii) the output of the non-saturating function applied to a discriminator score for a generated image and, optionally, (iii) one or more regularization terms.

FIG. 6 shows an example 600 of the training of the generator neural network 110.

As shown in the example 600, during training, the generator neural network 110 generates a respective “student” output image for each of the blocks 1 through N in the generator neural network 110. During training, the system also generates, using the teacher generator neural network, a respective “teacher” output image for each of the blocks 1 through N in the generator neural network 110, i.e., a teacher output image that has the same resolution as the student output image generated for the block.

The system then computes a perceptual loss between each corresponding pair of student and teacher output images. In the example 600, the perceptual loss is the difference, e.g., the mean-squared error, between features extracted from the pair of images by a pre-trained feature extractor neural network, e.g., the VGG19 backbone.

In the example of FIG. 6, the training system also uses the discriminator neural network as part of the training. Thus, the system processes the student output image having the target resolution using the discriminator neural network to generate as output a discriminator score that predicts whether the student output image is generated by the generator neural network. The system then uses the discriminator score in an adversarial loss to train the generator neural network and, in combination with realistic images, to train the discriminator neural network to accurately distinguish between student output images generated by the generator neural network and the realistic images. By using realistic images (e.g., real images), which may not have been images generated by the teacher model, when training the discriminator, the student model trained using the described techniques can be capable of suppressing artifacts from the teacher model.

In some implementations, after this training, the system can fine-tune the neural network to customize the neural network on a particular input style. For example, the particular input style can be defined by a set of representative images that are provided by a user. In some cases, this set of images can include as few as one or two images.

For example, to perform this fine-tuning, the system can make use of the encoder neural network described above. During the fine-tuning process, the system freezes the encoder module and only fine-tunes the generator neural network. As part of this training process, the system samples multiple latent codes close to the encoding output of the input style images as the input to the generator neural network. The system then trains the generator neural network to reconstruct an input image, e.g., an image of a person's face, in the style of the input style image, e.g., by optimizing a joint adversarial loss function that also accounts for style and content. With such a fine-tuning process, the system can adapt to the customized style, which approximates the user's input. It can then be applied to stylize test images of real human faces.

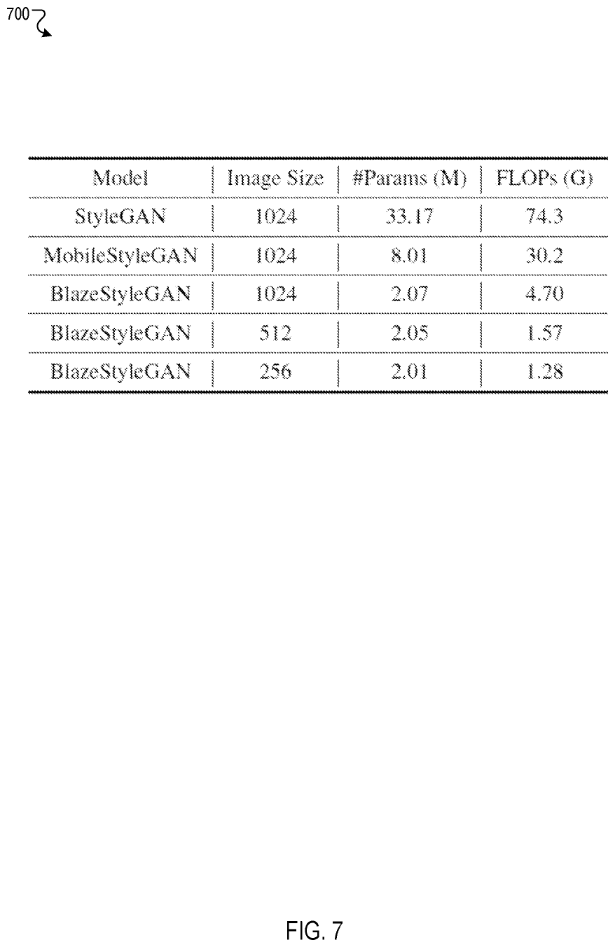

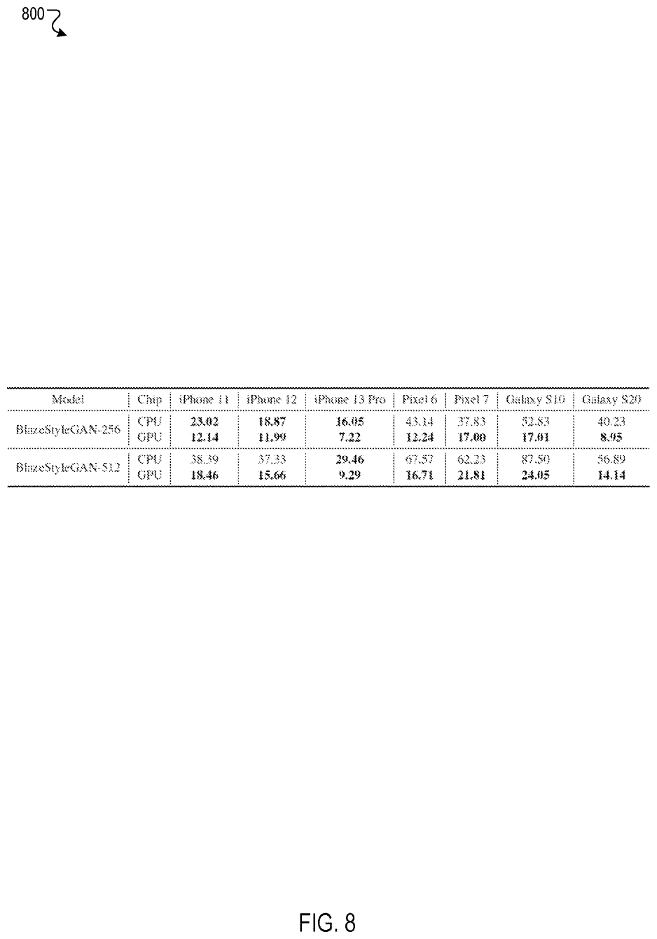

FIG. 7 shows an example 700 of the computational efficiency (“BlazeStyleGAN”) of the described techniques relative to existing techniques that also generate images of faces (“StyleGAN” and “MobileStyleGAN”). As can be seen from the example 700, the described techniques result in, for a given input image size, an architecture that has significantly fewer parameters (measured in millions of parameters) and that requires significantly fewer FLOPs than these other architectures. As will be seen in FIG. 8, this allows the described neural network to run in real-time on mobile devices, while these existing architectures cannot.

FIG. 8 shows an example 800 of the inference times (in milliseconds) of the described techniques when deployed on common mobile devices.

As shown in the example 800, the described techniques yield architectures that can generate images in real-time (less than 30 ms) on the GPU of all of the devices and can even generate images in real-time on the CPU of some of the devices.

Additionally, as can be seen from Table 1, below, the described techniques preserve the image quality of these other, more computationally expensive architectures.

TABLE 1

| | Teacher StyleGAN | BlazeStyleGAN |
|---|---|---|
| FID-256 | 6.64 | 9.94 |
| FID-512 | 4.33 | 8.96 |

As can be seen from Table 1, the described techniques achieve comparable performance in terms of FID score to the teacher generator neural network used in the training despite being significantly more computationally efficient.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a conditioning input; and
generating an output image having a target resolution conditioned on the conditioning input by processing the conditioning input through a generator neural network, comprising:
initializing a latent representation of the output image to have an initial resolution;
processing the latent representation through a sequence of convolutional layer blocks, wherein each convolutional layer block is configured to upsample the latent representation by performing operations comprising:
receiving the latent representation;
generating, from the latent representation, an upsampled latent representation having a corresponding resolution for the convolutional layer block by processing the latent representation through an upsampling layer block; and
updating the latent representation by processing the upsampled latent representation through one or more styled convolutional layer blocks that are each conditioned on the conditioning input, wherein (i) the corresponding resolution for the last convolutional layer block in the sequence is lower than the target resolution and (ii) for each convolutional block after the first convolutional layer block in the sequence, the corresponding resolution for the convolutional layer block is higher than the corresponding resolution for the preceding convolutional layer block in the sequence; and
processing the latent representation after being updated by the last convolutional layer block in the sequence using an output head, wherein the output head is configured to perform operations comprising:
generating, from the latent representation, a final upsampled latent representation having the target resolution by processing the latent representation through an upsampling layer block; and
applying a depthwise separable modulated convolution conditioned on the conditioning input to the final upsampled latent representation to generate an initial output image having the target resolution.

2. The method of claim 1, wherein obtaining the conditioning input comprises:
obtaining an input latent representation; and
processing the input latent representation using a mapping neural network to generate the conditioning input.

3. The method of claim 2, wherein the input latent representation is sampled from a distribution.

4. The method of claim 2, wherein obtaining an input latent representation comprises:
receiving an input characterizing properties of the target image; and
processing the input characterizing the properties of the target image to generate the input latent representation.

5. The method of claim 4, wherein the input characterizing properties of the target image is an input image and wherein the target image is an edited version of the input image.

6. The method of claim 1, wherein the operations performed by the output block further comprise:
adding a bias to the initial output image to generate the output image having the target resolution.

7. The method of claim 1, wherein the depthwise separable modulated convolution applied by the output block is a depthwise separable modulated convolution with trainable demodulation.

8. The method of claim 1, wherein, for each convolutional layer block, the upsampling layer block is configured to:
apply an upsampling operation to the latent representation to generate an initial upsampled latent representation having the corresponding resolution for the convolutional layer block; and
process the initial upsampled latent representation through a depthwise separable convolution block to generate the upsampled latent representation.

9. The method of claim 1, wherein the upsampling layer block for the output head is configured to:
apply an upsampling operation to the latent representation to generate an initial upsampled latent representation having the target resolution; and
process the initial upsampled latent representation through a depthwise separable convolution block to generate the final upsampled latent representation.

10. The method of claim 1, wherein, for each convolutional layer block, each styled convolutional layer block is configured to:
update the upsampled latent representation by processing the upsampled latent representation through a depthwise separable modulated convolution layer.

11. The method of claim 10, wherein, for each convolutional layer block, each styled convolutional layer block is further configured to:
add noise to the updated upsampled latent representation.

12. The method of claim 1, wherein the generator neural network has been trained by performing training operations comprising:
obtaining a batch of training conditioning inputs;
processing each training conditioning input through a teacher generator neural network to generate, for each training conditioning input, a plurality of training teacher images, wherein each training teacher image has a respective teacher target resolution, and wherein one of the teacher target resolutions is the target resolution;
processing each training conditioning input through the generator neural network to generate, for each training conditioning input, a training output image having the target resolution and a respective latent representation having the resolution corresponding to each of the convolutional layer blocks;
for each training conditioning input and for each convolutional layer block, processing the respective latent representation having the resolution corresponding to the convolutional layer block using a corresponding auxiliary output head to generate as output a training output image having a corresponding one of the teacher target resolutions; and
training the generator neural network and the corresponding auxiliary output heads on an objective that measures, for each training conditioning input and for each teacher target resolution, a difference between the training teacher image having the teacher target resolution and the training output image having the teacher target resolution.

13. The method of claim 12, wherein the difference is a perceptual loss between the training teacher image having the teacher target resolution and the training output image having the teacher target resolution.

14. The method of claim 12, wherein the training operations further comprise:
for each training conditioning input, processing the training output image having the target resolution using a discriminator neural network to generate as output a discriminator score that predicts whether the training output image is generated by the generator neural network; and
wherein the objective also includes a term that is based on the discriminator scores for the training conditioning inputs.

15. The method of claim 14, wherein the training operations further comprise:
training the discriminator neural network to accurately distinguish between training output images generated by the generator neural network and real images obtained from an existing data set of images.

16. A system comprising:
one or more computers; and
one or more storage devices storing instructions that, when executed by the one or more computers, cause the one or more computers to perform operations comprising:
obtaining a conditioning input; and
generating an output image having a target resolution conditioned on the conditioning input by processing the conditioning input through a generator neural network, comprising:
initializing a latent representation of the output image to have an initial resolution;
processing the latent representation through a sequence of convolutional layer blocks, wherein each convolutional layer block is configured to upsample the latent representation by performing operations comprising:
receiving the latent representation;
generating, from the latent representation, an upsampled latent representation having a corresponding resolution for the convolutional layer block by processing the latent representation through an upsampling layer block; and
updating the latent representation by processing the upsampled latent representation through one or more styled convolutional layer blocks that are each conditioned on the conditioning input, wherein (i) the corresponding resolution for the last convolutional layer block in the sequence is lower than the target resolution and (ii) for each convolutional block after the first convolutional layer block in the sequence, the corresponding resolution for the convolutional layer block is higher than the corresponding resolution for the preceding convolutional layer block in the sequence; and
processing the latent representation after being updated by the last convolutional layer block in the sequence using an output head, wherein the output head is configured to perform operations comprising:
generating, from the latent representation, a final upsampled latent representation having the target resolution by processing the latent representation through an upsampling layer block; and
applying a depthwise separable modulated convolution conditioned on the conditioning input to the final upsampled latent representation to generate an initial output image having the target resolution.

17. One or more non-transitory computer-readable storage media storing instructions that when executed by one or more computers cause the one or more computers to perform operations comprising:
obtaining a conditioning input; and
generating an output image having a target resolution conditioned on the conditioning input by processing the conditioning input through a generator neural network, comprising:
initializing a latent representation of the output image to have an initial resolution;
processing the latent representation through a sequence of convolutional layer blocks, wherein each convolutional layer block is configured to upsample the latent representation by performing operations comprising:
receiving the latent representation;
generating, from the latent representation, an upsampled latent representation having a corresponding resolution for the convolutional layer block by processing the latent representation through an upsampling layer block; and
updating the latent representation by processing the upsampled latent representation through one or more styled convolutional layer blocks that are each conditioned on the conditioning input, wherein (i) the corresponding resolution for the last convolutional layer block in the sequence is lower than the target resolution and (ii) for each convolutional block after the first convolutional layer block in the sequence, the corresponding resolution for the convolutional layer block is higher than the corresponding resolution for the preceding convolutional layer block in the sequence; and
processing the latent representation after being updated by the last convolutional layer block in the sequence using an output head, wherein the output head is configured to perform operations comprising:
generating, from the latent representation, a final upsampled latent representation having the target resolution by processing the latent representation through an upsampling layer block; and
applying a depthwise separable modulated convolution conditioned on the conditioning input to the final upsampled latent representation to generate an initial output image having the target resolution.

18. The system of claim 16, wherein obtaining the conditioning input comprises:
obtaining an input latent representation; and
processing the input latent representation using a mapping neural network to generate the conditioning input.

19. The system of claim 18, wherein obtaining an input latent representation comprises:
receiving an input characterizing properties of the target image; and
processing the input characterizing the properties of the target image to generate the input latent representation.

20. The system of claim 19, wherein the input characterizing properties of the target image is an input image and wherein the target image is an edited version of the input image.
